(19) United States
(12) Patent Application Publication
(10) Pub. No.: US 2007/0215060 A1
(43) Pub. Date: Sep. 20, 2007

(54) Fish aquarium

(76) Inventor: Chih-Hung Lin, Taichung City (TW)

Correspondence Address: BIRCH STEWART KOLASCH & BIRCH, PO BOX 747, FALLS CHURCH, VA, 22040-0747, US

(21) Appl. No.: 11/312,374

(22) Filed: Dec. 21, 2005

(51) Int. Cl. A01K 63/00

(52) U.S. Cl. 119/245

(57) ABSTRACT

A fish aquarium has a connecting slice, a first side-slice and a second side-slice. The connecting slice has a joint and two thermal-pressed sections. The first side-slice is attached to one of the thermal-pressed sections and has a printed pattern and a buckled chain mounted on the first side-slice near the distal edge. The second side-slice is attached to the other thermal-pressed section and has a buckled chain near the distal edge to engage with the buckled chain of the first side slice. The first side-slice and the second side-slice are combined together with a thermal compression process to form a thermal-sealed segment, a thermal-seal line, an interior space and an opening between the side-slices.

### BACKGROUND OF THE INVENTION

1. Field of the Invention

The present invention relates to a fish aquarium, and more particularly to a fish aquarium that is made of a plastic film and can be fabricated quickly and carried conveniently.

2. Description of Related Art

Conventional fish aquariums are used to culture fishes for enjoy or decoration. The conventional fish aquarium is always made of glass but is easily broken. However, the conventional fish aquarium also has the following shortcomings.

1. Because the conventional fish aquariums are made of glass, the cost for manufacturing a glass aquarium is high and the conventional glass aquarium is fragile and is easily broken to hurt person. To carry and to transport the conventional glass fish aquariums is inconvenient and troublesome.

2. The conventional fish aquarium usually has a solid body, such that to store and to transport the conventional aquarium need a large space and is inconvenient.

3. In addition, the appearance of the conventional fish aquarium cannot be painted to add attraction to people and is not aesthetic.

### SUMMARY OF THE INVENTION

The main objective of the present invention is to provide a fish aquarium that is easy for manufacturing and convenient for storing.

A fish aquarium has a connecting slice, a first side-slice and a second side-slice. The connecting slice has a joint and two thermal-pressed sections. The first side-slice is attached to one of the thermal-pressed sections and has a printed pattern and a buckled chain mounted on the first side-slice near the distal edge. The second side-slice is attached to the other thermal-pressed section and has a buckled chain near the distal edge to engage with the buckled chain of the first side slice. The first side-slice and the second side-slice are combined together with a thermal compression process to form a thermal-sealed segment, a thermal-seal line, an interior space and an opening between the side-slices.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a fish aquarium in accordance with the present invention;

FIG. 2 is an exploded perspective view of the fish aquarium in FIG. 1;

FIG. 3 is an operational perspective view of the fish aquarium in FIG. 1;

FIG. 4 is an operational perspective view of the fish aquarium with two straps in FIG. 1; and

FIG. 5 is a perspective view of another embodiment of a fish aquarium in accordance with the present invention without comprising hanger holes; and

FIG. 6 is a perspective view of a further embodiment of a fish aquarium in accordance with the present invention comprising a sealed slice.

### DETAILED DESCRIPTION OF THE PREFERRED EMBODIMENT

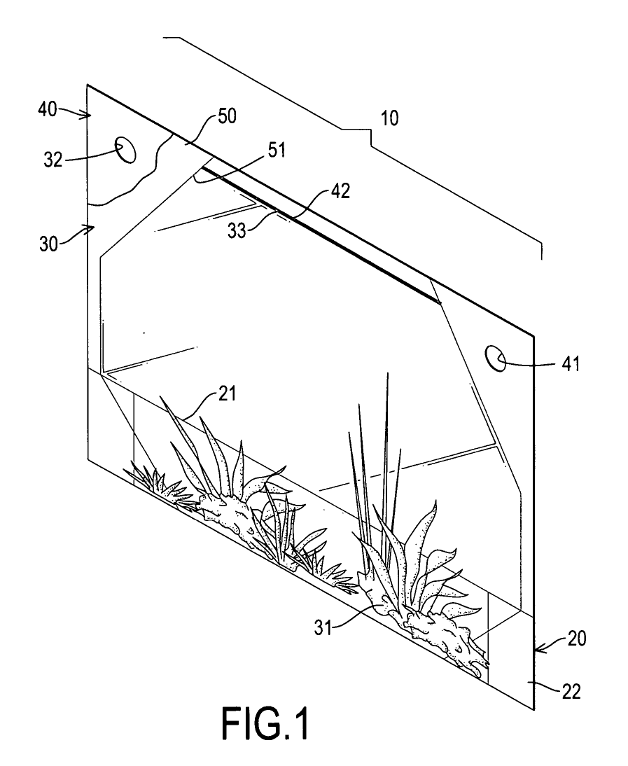

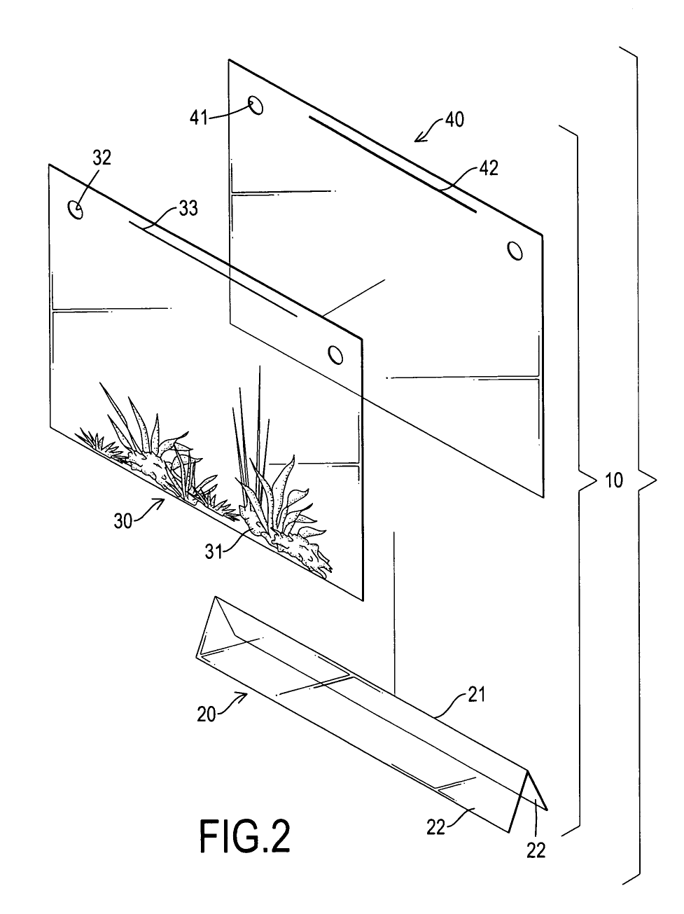

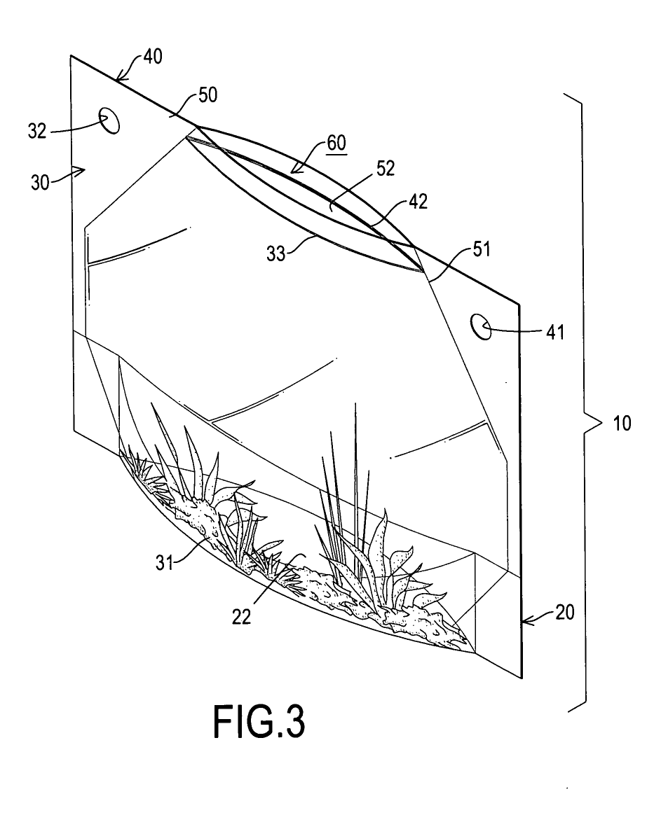

With reference to FIGS. 1, 2 and 3, a fish aquarium (10) in accordance with the present invention comprises a connecting slice (20), a first side-slice (30) and a second side-slice (40).

The connecting slice (20) is rectangular and made of a plastic film and has a centerline, a joint (21) and two thermal-pressed sections (22). The joint (21) is superimposed over the centerline and the thermal-pressed sections (22) are formed respectively on two sides of the joint (21).

The first side-slice (30) is also made of a plastic film and mounted on one of the thermal-pressed sections (22) and has a distal edge, a proximal edge, an external surface, a printed pattern (31), two hanger holes (32) and a buckled chain (33). The proximal edge of the first side-slice (30) is thermally combined with one of the thermal-pressed sections (22), and the printed pattern (31) is formed on the external surface of the first side-slice (30) near the corresponding thermal-pressed section (22). The hanger holes (32) are formed through the first side-slice (30) near the distal edge, and the buckled chain (33) is mounted on the first side-slice (30) near the distal edge.

The second side-slice (40) is made of a plastic film and mounted on the other thermal-pressed section (22) and has a distal edge, a proximal edge, an external surface, two hanger holes (41) and a buckled chain (42). The proximal edge of the second side-slice (30) is also thermally combined with the corresponding thermal-pressed section (22). The hanger holes (41) are formed through the second side-slice (30) near the distal edge and correspond respectively to the hanger holes (32) in the first side-slice (30). The buckled chain (42) is mounted on the second side-slice (30) near the distal edge and is detachably engaged with the buckled chain (33) on the first side-slice (30).

The first side-slice (30) and the second side-slice (40) are combined together with a thermal compression process to form an interior space (52), an opening (60), a thermal-sealed segment (50) and a thermal-seal line (51) between the side-slices (30) (40). The interior space (52) is formed between the two side slices (20) (30) and the opening (60) is formed between the side-slices (30) (40) near the distal edges and communicating with the interior space (52). The thermal-sealed segment (50) is formed around the interior space (52), and the thermal-seal line (51) is formed between the thermal-sealed segment (50) and the interior space (52). The hanger holes (41) are defined in the thermal-sealed segment (50) respectively at two sides of the opening (60).

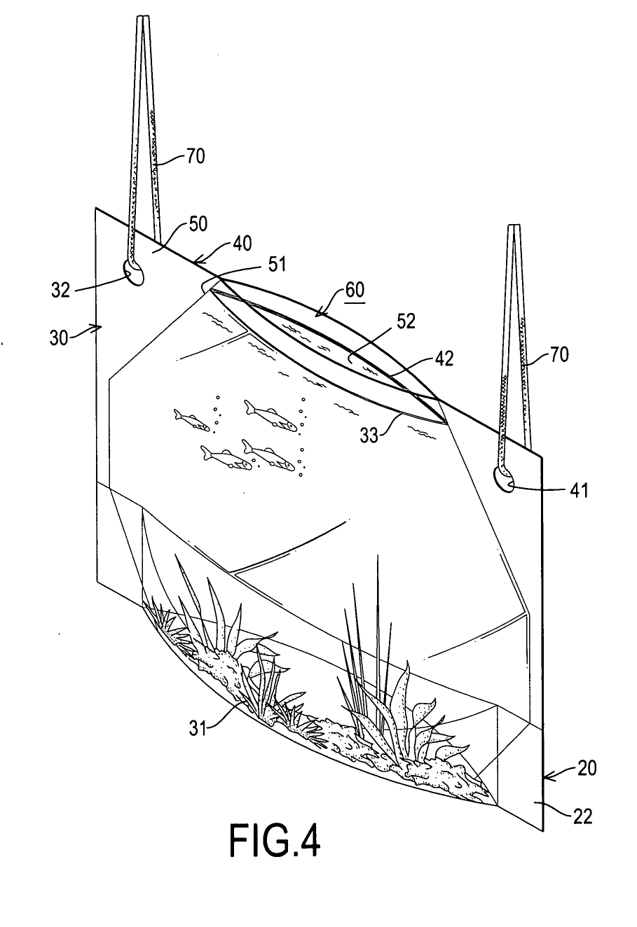

Accordingly, a user can put fluid and fishes into the interior space (52) through the opening (60). Consequently, the fish aquarium (10) serves as a container to culture fishes. In addition, the printed pattern (31) on the external surface of the first side-slice (30) provides an ornamental effect. With further reference to FIG. 4, two straps (70) respectively extends through the hanger holes (32) (41) to allow a user to carry the fish aquarium (10) easily and conveniently.

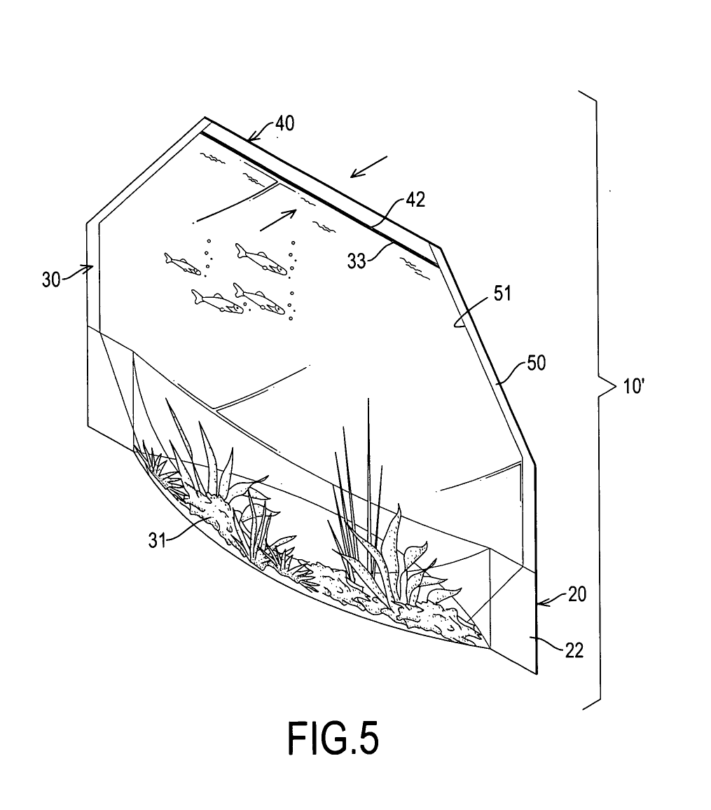

With further reference to FIG. 5, another embodiment of a fish aquarium (10′) in accordance with the present invention has a structure substantially same as that of the previous embodiment except that the thermal-sealed segment (50) is cut off near the hanger holes (32) (41) to provide a simplified structure and appearance. To seal the fish aquarium (10′) with the buckled chains (33) (42) engaging with each other to prevent the fluid from flowing over the fish aquarium (10).

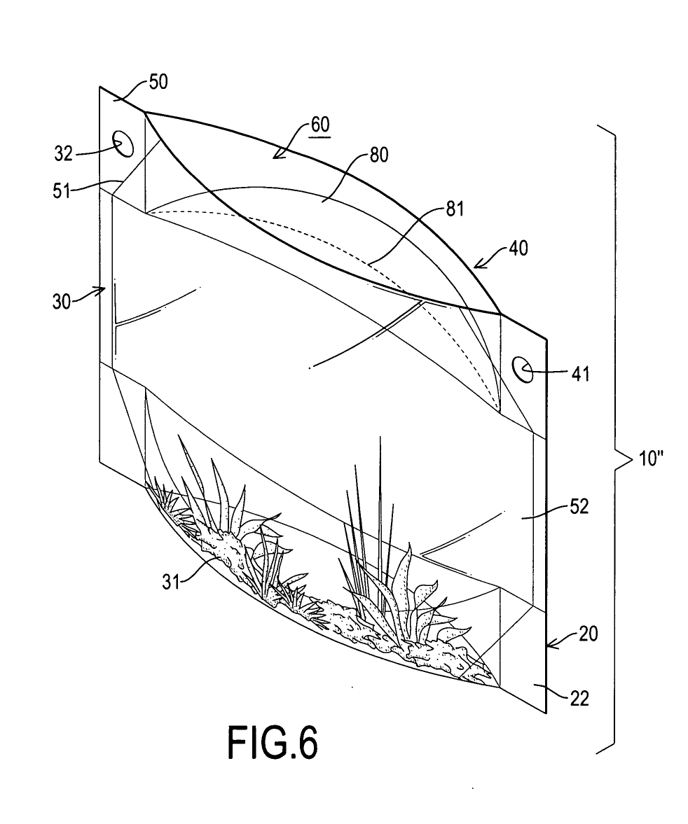

With further reference to FIG. 6, a further embodiment of a fish aquarium (10″) in accordance with the present invention further comprises a sealed-slice (80) attached to and closes the opening (60) and having a center and a cutting line (81). The cutting line (81) is formed on the center of the sealed-slice (80), such that user can open the opening (60) by cutting off the cutting line (81).

The fish aquarium (10) as described has the following advantages.

1. The fish aquarium (10) is made of plastic films, such that to form or to manufacture the fish aquarium (10) is easy and the cost for manufacturing the aquarium (10) is lowered. In addition, the plastic aquarium (10) will not injure any person even when the aquarium (10) is broken, the safety of using the aquarium (10) is improved. The aquarium (10) made of a plastic material has a lightly weight and is conveniently carried and transported.

2. The fish aquarium (10) has a small volume, such that the space and cost for storing or transporting the fish aquarium (10) are reduced.

3. The printed or painted pattern (31) on the external surface of the fish aquarium (10) can improve the appearance to provide an aesthetic effect.

Even though numerous characteristics and advantages of the present utility model have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A fish aquarium having
a connecting slice being rectangular and having
a centerline;
a joint superimposed over the centerline; and
two thermal-pressed sections formed on the connecting slice and respectively at two sides of the joint;
a first side-slice attached to one of the thermal-pressed sections and having
a distal edge;
a proximal edge thermally combined with the corresponding thermal-pressed section;
an external surface; and
a printed pattern formed on the external surface of the first side-slice near the corresponding thermal-pressed section; and
a second side-slice mounted on the other thermal-pressed section and having
a distal edge;
a proximal edge thermally combined with the corresponding thermal-pressed section; and
an external surface;
wherein the first side-slice and the second side-slice are combined together with a thermal compression process to define
an interior space between the two side slices;
an opening between the side-slices near the distal edges and communicating with the interior space;
a thermal-sealed segment formed around the interior space; and
a thermal-seal line between the thermal-sealed segment and the interior space.

2. The fish aquarium as claimed in claim 1, wherein a buckled chain mounted on the first side-slice near the distal edge, and a buckled chain mounted on the second side-slice near the distal edge and engaged with the buckled chain in the first side-slice to close the opening.

3. The fish aquarium as claimed in claim 2, wherein two hanger holes are defined through the thermal-sealed segment respectively at two sides of the opening.

4. The fish aquarium as claimed in claim 3, wherein two straps extend respectively through the hanger holes.

5. The fish aquarium as claimed in claim 4, wherein a sealed-slice is attached to the side-slices to close the opening and has a center and a cutting line formed on the center of the sealed-slice.

6. The fish aquarium as claimed in claim 1, wherein two hanger holes are defined through the thermal-sealed segment respectively at two sides of the opening.

7. The fish aquarium as claimed in claim 1, wherein two straps extend respectively through the hanger holes.

8. The fish aquarium as claimed in claim 1, wherein a sealed-slice is attached to the side-slices to close the opening and has a center and a cutting line formed on the center of the sealed-slice.
